(19) United States
(12) Patent Application Publication
(10) Pub. No.: US 2015/0146132 A1
(43) Pub. Date: May 28, 2015

(54) SURFACE LIGHT SOURCE DEVICE, DISPLAY DEVICE, AND LIGHTING DEVICE

(71) Applicant: Sharp Kabushiki Kaisha, Osaka (JP)

(72) Inventors: Shohei Katsuta, Osaka (JP); Tsuyoshi Kamada, Osaka (JP); Daisuke Shinozaki, Osaka (JP); Masahiro Tsujimoto, Osaka (JP)

(73) Assignee: Sharp Kabushiki Kaisha, Osaka (JP)

(21) Appl. No.: 14/405,221

(22) PCT Filed: Jun. 7, 2013
(86) PCT No.: PCT/JP2013/065788

§ 371 Date: Dec. 3, 2014

(30) Foreign Application Priority Data
Jun. 7, 2012 (JP) 2012-129739

(51) Int. Cl. F21V 13/04; F21V 9/14; F21V 5/04; G02F 1/1335

(52) U.S. Cl. CPC F21V 13/04; G02F 1/133615; F21V 9/14; F21V 5/04; G02F 2001/133614
USPC 349/61; 362/311.01; 362/297; 362/311.1; 362/311.07; 362/19

(57) ABSTRACT

Provided is a surface light source device capable of producing directed light. The surface light source device according to the present invention is provided with: LEDs (light source); a case having a light-emitting surface provided with at least one opening (a light-transmitting part), and enabling the light from the LED to be repeatedly reflected and guided within an internal space, and emitted through the aperture part; and a lens sheet (lens member) that is disposed facing the light-emitting surface of the casing and includes at least one lens. The position of the focal point of the lens is substantially the same as the position of the aperture.

### TECHNICAL FIELD

The present invention relates to a planar light source device, a display device, and an illumination device.

### BACKGROUND ART

As an example of a display device, a transmissive liquid crystal display device that performs display using light emitted from a planar light source device is known. One type of liquid crystal display device has a liquid crystal panel and a planar light source device disposed on the rear surface side of the liquid crystal panel. Conventional planar light source devices generally included light sources such as light emitting diodes (hereinafter abbreviated as LEDs), and a light guide plate. In this type of planar light source device, light emitted from the light sources was propagated through the light guide plate, and emitted from the front surface of the light guide plate. Below, in the present specification, a planar light source device disposed on the rear surface side of the display panel is sometimes referred to as a backlight.

Conventional backlights disclosed in Patent Documents 1 and 2 below have been proposed.

In Patent Document 1 discloses a backlight device including a light-emitting device, a slab wave guide, a substrate, microprisms, and microlenses. In this backlight device, light emitted from the substrate is made parallel by the microprisms and further made parallel by the microlenses.

Patent Document 2 discloses a backlight including a front surface reflective body and a rear surface reflective body, which form a hollow light recycling cavity. In this backlight, light from the light sources is reflected a plurality of times between the front surface reflective body and the rear surface reflective body and propagated through the cavity, and then outputted from the output surface.

### RELATED ART DOCUMENTS

### Patent Documents

Patent Document 1: Japanese Patent No. 2706574
Patent Document 2: Japanese Translation of PCT International Application Publication No. 2011-514624

### SUMMARY OF THE INVENTION

### Problems to be Solved by the Invention

In the backlight device of Patent Document 1, of the light emitted from the substrate, only the light entering the microprisms is emitted outside. Thus, the light emission rate is low. In order to adjust the light emission rate, there is a need to adjust the area taken up by the microprisms and the gap between the microprisms, and thus, the adjustment of the light emission rate is complicated.

In the backlight of Patent Document 2, light from the light sources is reflected in the cavity a plurality of times, and light is emitted as it is propagated through the cavity. However, light having a few angular components is emitted, and thus, it is difficult to attain light having directivity.

The present invention takes into account the above-mentioned problem, and an object thereof is to provide a planar light source device by which it is possible to attain light having directivity. Another object is to provide a display device and an illumination device including such a planar light source device.

### Means for Solving the Problems

In order to attain the above-mentioned object, a planar light source device according to the present invention includes: a case having a light source and a light-emitting surface provided with at least one light-transmissive portion, the case guiding light from the light source as said light is reflected a plurality of times in an interior space of the case and emitting the light from the light-transmissive portion; a lens member including at least one unit lens disposed to face the light-emitting surface of the case, wherein a focal point of the unit lens substantially matches the light-transmissive portion in position.

In a planar light source device of the present invention, a plurality of the light-transmissive portions are provided in the light-emitting surface of the case, and the lens member includes a plurality of the unit lenses respectively corresponding in position to the plurality of light-transmissive portions.

In a planar light source device of the present invention, the light-transmissive portion is an opening provided in the case.

In a planar light source device of the present invention, at least some inner surfaces of the case are scatter-reflective surfaces that reflect and scatter light from the light source.

In a planar light source device of the present invention, at least some inner surfaces of the case are specular reflective surfaces that specularly reflect light from the light source.

In a planar light source device of the present invention, the unit lens is a double convex lens.

In a planar light source device of the present invention, the unit lens is a plano-convex lens.

In a planar light source device of the present invention, wherein the unit lens is a parabolic lens.

In a planar light source device of the present invention, the lens member includes an alignment portion for aligning the focal point of the unit lens in position with the light-transmissive portion.

In a planar light source device of the present invention, the alignment portion is a protrusion of the unit lens inserted into the opening that is the light-transmissive portion.

In a planar light source device of the present invention, the light-transmissive portion is circular in a plan view when viewed from a direction normal to the light-emitting surface of the case.

In a planar light source device of the present invention, the light-transmissive portion has a shape other than a circle in a plan view when viewed from a direction normal to the light-emitting surface of the case.

In a planar light source device of the present invention, the unit lens is polygonal in a plan view when viewed from a direction normal to the light-emitting surface of the case.

A planar light source device of the present invention, includes: a light focusing member in the inner space of the case, the light focusing member focusing light guided in the inner space at the light-transmissive portion.

In a planar light source device of the present invention, the light focusing member is a telecentric lens.

A planar light source device of the present invention further includes: a selective polarization element on a light emitting side of the lens member, the selective polarization element allowing through a first polarized light and reflecting a second polarized light having a differing polarization state from the first polarized light among the light emitted from the lens member.

In a planar light source device of the present invention, a portion of the outer surface of the case facing the lens member is a light-absorbing surface.

A display device of the present invention includes: the planar light source device; and a display element that performs display using light emitted from the planar light source device.

In a display device of the present invention, the display element is a liquid crystal panel that modulates a transmittance of light emitted from the planar light source device.

A display device of the present invention further includes: a light scattering member for increasing a scattering angle of light emitted from the liquid crystal panel, the light scattering member being disposed on a light-emitting side of the liquid crystal panel.

In a display device of the present invention, the display element is a fluorescent display that emits fluorescent light as light excited by the light from the planar light source device.

An illumination device of the present invention includes: the planar light source device.

### Effects of the Invention

According to the present invention, it is possible to provide a planar light source device by which it is possible to attain light having directivity, and a display device including this planar light source device. According to the present invention, it is possible to provide a display device and an illumination device including the planar light source device.

### BRIEF DESCRIPTION OF THE DRAWINGS

FIG. 1 is a perspective view of a planar light source device of Embodiment 1.

FIG. 2 is a plan view of the planar light source device.

FIG. 3 is a cross-sectional view along the line A-A′ of FIG. 1.

FIG. 4 shows a path of light in the planar light source device.

FIG. 5 is a cross-sectional view along the line B-B′ of FIG. 1.

FIG. 6 is a perspective view of a planar light source device of Embodiment 2.

FIG. 7 is a plan view of the planar light source device.

FIG. 8 is a plan view of a planar light source device according to Modification Example 1.

FIG. 9 is a cross-sectional view of a main portion of a planar light source device of Embodiment 3.

FIG. 10 shows a path of light in the planar light source device.

FIG. 11 is a cross-sectional view of a main portion of a planar light source device of Embodiment 4.

FIG. 12 shows a path of light in the planar light source device.

FIG. 13 is a plan view of a planar light source device of Embodiment 5.

FIG. 14(A) shows a path of light in a cross-section along the line A-A′ of FIG. 13, and FIG. 14(B) shows a path of light in a cross-section along the line B-B′ of FIG. 13.

FIGS. 15(A) to 15(C) are plan views showing modification examples of the plan view shape of an opening.

FIG. 16 is a cross-sectional view of a planar light source device of Embodiment 6.

FIG. 17 is a cross-sectional view of a planar light source device of Embodiment 7.

FIG. 18 shows a path of light in the planar light source device.

FIG. 19 is a cross-sectional view of a display device of Embodiment 8.

FIG. 20 is a cross-sectional view of a display device of Embodiment 9.

FIG. 21 is a front view of the display device.

FIG. 22 is a cross-sectional view of an illumination device of Embodiment 10.

### DETAILED DESCRIPTION OF EMBODIMENTS

### Embodiment 1

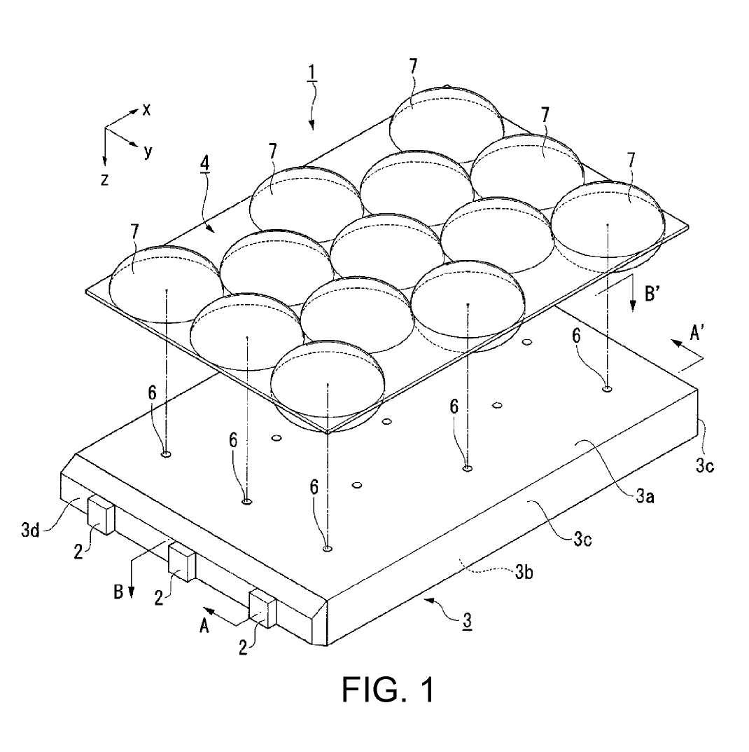

Below, Embodiment 1 of the present invention will be described with reference to FIGS. 1 to 5.

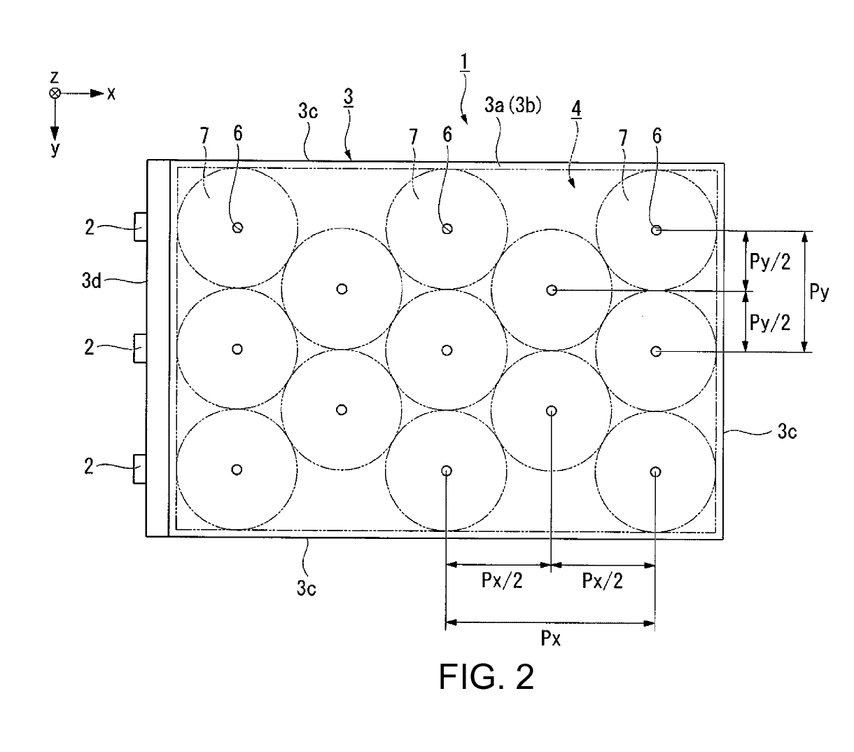

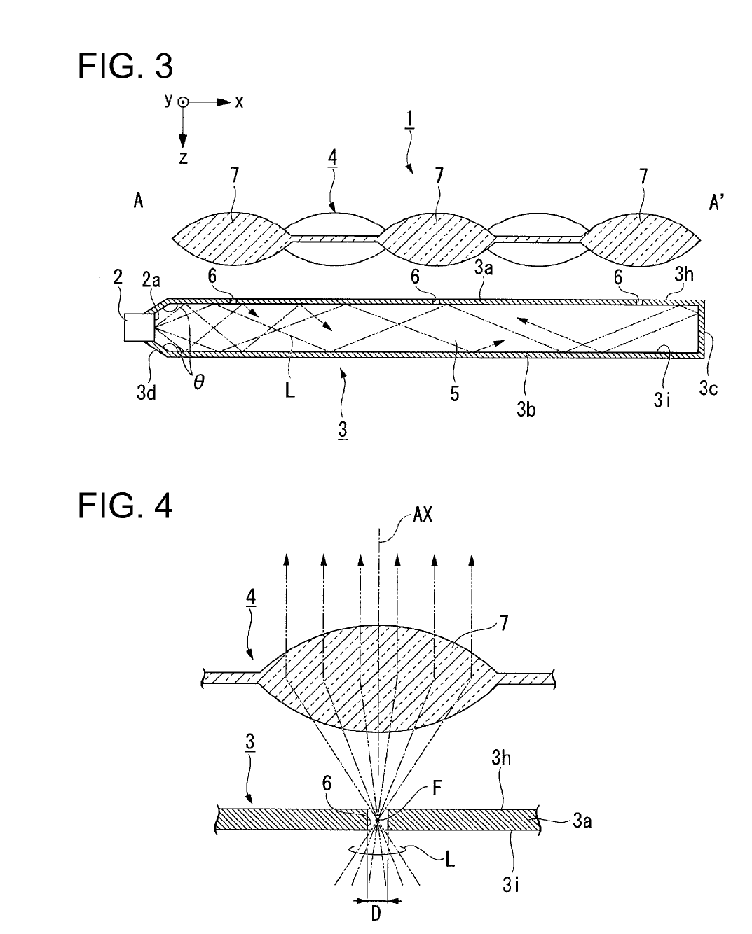

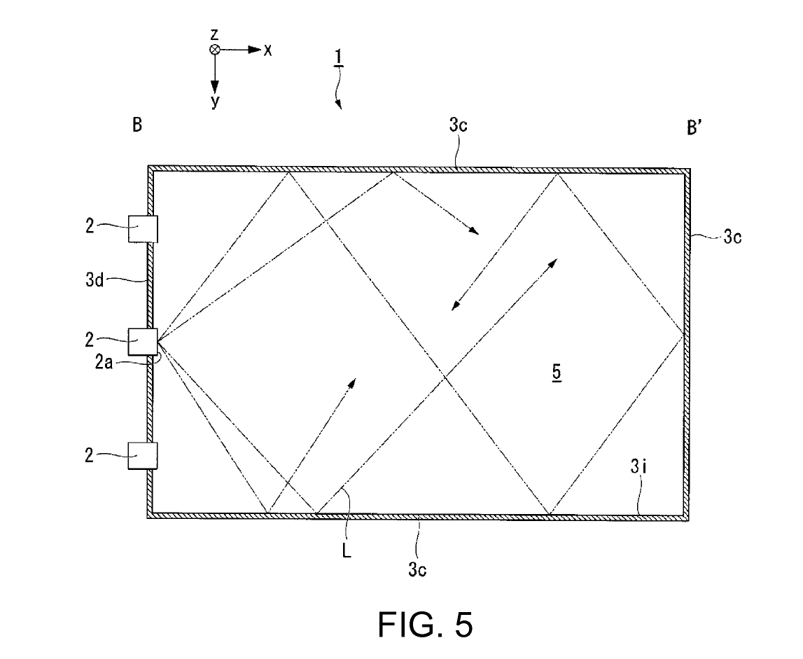

FIG. 1 is a perspective view of a planar light source device of the present embodiment. FIG. 2 is a plan view of the planar light source device. FIG. 3 is a cross-sectional view along the line A-A′ of FIG. 1. FIG. 4 shows a path of light in the planar light source device. FIG. 5 is a cross-sectional view along the line B-B′ of FIG. 1.

In order for the components in the respective drawings below to be easy to see, the components are sometimes shown with differing dimensional scales.

As shown in FIG. 1, the planar light source device 1 of the present embodiment includes a plurality of light emitting diodes 2 (hereinafter LEDs) constituting the light source, a case 3, and a lens sheet 4 (lens member). The lens sheet 4 is disposed to face a top plate 3a of the case 3 to be described later. In FIG. 1, the lens sheet 4 and the case 3 are depicted to be separate from each other in order to make the drawing easier to see. In reality, the lens sheet 4 and the case 3 are positioned close to each other. The lens sheet 4 and the case 3 may be attached to each other.

The case 3 has a substantially rectangular cuboid shape. As shown in FIGS. 3 and 5, the inside of the case 3 is hollow and air is present therein. As shown in FIG. 2, the top plate 3a and a bottom plate 3b of the case 3 have a rectangular shape in a plan view as seen from the direction normal to the case 3. As shown in FIG. 3, the top plate 3a and the bottom plate 3b are plate members parallel to the xy plane, and parallel to each other. Of four side plates 3c and 3d surrounding the periphery of the top plate 3a and the bottom plate 3b, a plurality of LEDs 2 are provided on one side plate 3d at a shorter side of the top plate 3a and the bottom plate 3b.

The plurality of LEDs 2 are provided to be equidistant to each other along the y axis direction and located in the center of the side plate 3d in the height direction. Three LEDs 2 are used in the present embodiment, but the number of LEDs 2 is not limited to three; there may be any number of LEDs 2 as long as there is at least one. The side plate 3d on which the LEDs 2 are provided is inclined towards the center where the LEDs 2 are provided respectively from the shorter sides of the top plate 3a and the bottom plate 3b, and have tapered surfaces at an angle θ greater than 90° with respect to the top plate 3a or the bottom plate 3b and less than 180°.

There is no need for the LEDs 2 to have specific functions or characteristics, and general commercially available LEDs 2 can be used. Overall, the planar light source device 1 needs to emit light having directivity, but the LEDs 2 need not emit light having directivity. It is possible to use LEDs 2 that emit general diffuse light. The LEDs 2 are fixed to the case 3 such that the light-emitting surface 2a of each LED 2 faces the interior of the case 3. As a result, the LEDs 2 emit light towards the interior space of the case 3. Below, the interior space of the case 3 will be referred to as a cavity 5.

There is no special limitation on the material of the case 3, which is made of various materials such as metal or plastic, for example. However, inner surfaces 3i of the case 3 facing the cavity 5 need to be reflective surfaces to reflect light. This is because the light emitted from the LEDs 2 needs to be guided in the cavity 5 while being reflected a plurality of times by the inner surfaces 3i of the case 3. Therefore, in order to minimize light loss during reflection, it is preferable that the reflectance of the inner surfaces 3i of the case 3 be as high as possible. Therefore, if the case 3 is made of plastic, for example, then a reflective film made of a high reflectance material may be provided on the inner surfaces 3i of the case 3.

At least some of the inner surfaces 3i of the case 3 may be scatter-reflective surfaces that reflect and scatter light emitted from the LEDs 2. At some of the inner surfaces 3i of the case 3 may be specular reflective surfaces that specularly reflect light emitted from the LEDs 2. All of the inner surfaces 3i of the case 3 may be scatter-reflective surfaces or all of the inner surfaces 3i of the case 3 may be specular reflective surfaces. Alternatively, the specular reflective surface and the scatter-reflective surface may coexist such that the inner surface 3i at the top plate 3a is a specular reflective surface and the inner surface 3i at the bottom plate 3b is a scatter-reflective surface. The case 3 may be formed integrally or be assembled of a plurality of members.

As shown in FIGS. 1 and 2, the top plate 3 of the case 3 is provided with a plurality of openings 6 that communicate between the cavity 5 and the outside of the case 3. In the present embodiment, the openings 6 are circular in a plan view, and 13 openings 6 are provided in the top plate 3a of the case 3. The plurality of openings 6 are arranged in a regular fashion. If the x axis direction of FIG. 2 is the row direction and the y axis direction is the column direction, then in the column direction, in an odd numbered column from the right, three openings 6 are provided, and in an even numbered column, two openings 6 are provided. If a gap Py is one pitch length between openings 6 adjacent to each other in the y axis direction in the same column, then the two openings 6 in an even numbered column are offset by half a pitch length with respect to the three openings 6 in an odd numbered column.

In the row direction, three openings 6 are disposed in an odd numbered row from the top and two openings 6 are disposed in an even numbered row from the top. If a gap Px between openings 6 adjacent to each other in the x axis direction in the same row is one pitch length, then the two openings 6 in the even numbered row are offset by half a pitch length in the x axis direction with respect to the three openings in the odd numbered row. The total area taken up by the plurality of openings 6 is approximately 10% of the total area of the top plate 3a, for example.

A light L emitted from the LEDs 2 is repeatedly reflected by the inner surfaces 3i of the case 3, and guided inside the cavity 5. In other words, as shown in FIG. 3, the light L emitted by the LEDs 2 is repeatedly reflected by the inner surface 3i at the top plate 3a and the inner surface 3i at the bottom plate 3b when viewing an xz cross-section, and as shown in FIG. 5, when viewing an xy cross-section, the light is repeatedly reflected off of the four side plates 3c and 3d.

If the reflectance of the inner surfaces 3i of the case 3 is 95%, for example, then 5% of the light is lost during reflection, but a majority of the remaining light L is guided inside the cavity 5. The light L is guided inside the cavity 5 as long as it does not reach the openings 6 in the top plate 3a. The light L leaves the case 3 when it reaches the openings 6 in the top plate 3a. Thus, the top plate 3a of the case 3 in which the openings 6 are provided can be said to be the light-emitting surface for outputting the light L from the LEDs 2.

It is preferable that of the outer surface of the case 3, at least an outer surface 3h facing the lens sheet 4 be a light-absorbing surface coated in black, for example. This is in order for the outer surface 3h to absorb light reflected off of the light-receiving surface of the lens sheet 4 and returning to the case 3 such that the light is not reflected off of the outer surface 3h of the case 3 and scattered.

As shown in FIG. 1, the lens sheet 4 is a sheet-shaped member having a plurality of lenses 7 (unit lenses). The lens sheet 4 of the present embodiment has 13 lenses 7 having the same dimensions and the same shape. The 13 lenses 7 are arranged in a regular fashion. The lenses 7 are circular in a plan view as viewed from the optical axis direction, and are double convex lenses having two spherical convex surfaces. When viewing the lens sheet 4 in a direction normal thereto, as shown in FIG. 2, the lenses 7 are disposed such that the centers of the circular outline of the lenses 7 respectively match the openings 6 in position.

Similar to the arrangement of the openings 6, when viewing the arrangement of the lenses 7 in the column direction, there are three lenses 7 in an odd numbered column from the right edge and two lenses 7 in an even numbered column. If a gap Py is one pitch length between centers of lenses 7 adjacent to each other in the y axis direction in the same column, then the two lenses 7 in an even numbered column are offset by half a pitch length with respect to the three lenses 7 in an odd numbered column.

In the row direction, three lenses 7 are disposed in an odd numbered row from the top and two lenses 7 are disposed in an even numbered row from the top. If a gap Px between lenses 7 adjacent to each other in the x axis direction in the same row is one pitch length, then the two lenses 7 in the even numbered row are offset by half a pitch length in the x axis direction with respect to the three lenses 7 in the odd numbered row.

When viewing a cross-section of the lens sheet 4 and the case 3, as shown in FIG. 4, the lens 7 is disposed such that a focal point F of the lens 7 matches in position with an opening 6 corresponding to the lens 7. In other words, the focal point F of the lens 7 is located inside the opening 6 corresponding to the lens 7. The light L guided inside the cavity 5 is reflected a plurality of times on various inner surfaces 3i of the case 3, and reaches the opening 6. Thus, light L is emitted from the opening 6 at various angles. Even if the light L is emitted from the opening 6 at various angles, as long as the diameter D of the opening 6 is small to a certain degree, then only light L emitted from the focal point F or the vicinity thereof of the lens 7 enters the lens 7. Thus, light L entering the lens 7 from various angles is converted to light substantially parallel to an optical axis AX of the lens 7 and emitted from the lens 7 thereafter.

In the planar light source device 1 of the present embodiment, light L exits only from the openings 6 of the case 3. Thus, it is possible to attain light L having a high so-called directivity, said light L being substantially parallel to the optical axis AX of the lens 7 due to effects of the spherical surface lens having the focal point F in the opening 6. Also, light L emitted from the opening 6 of the case 3 is reflected multiple times inside the cavity 5, and thus, when the light is emitted from the case 3, the light distribution and luminance distribution are made even. As a result, the planar light source device 1 can attain light having an even light distribution and luminance distribution throughout the lens sheet 4.

In the planar light source device 1 of the present embodiment, the light L emitted from the LEDs 2 exits only through the openings 6 of the case 3, and thus, if the LEDs 2 are primary light sources, the openings 6 can be made to be secondary light sources. In other words, light L having a uniform light distribution and luminance distribution is emitted from the openings 6, which are secondary light sources. Therefore, there is no need to use LEDs 2, which are primary light sources, having excellent light distribution and luminance distribution, which allows for greater freedom in selecting LEDs 2 to be used.

The LEDs 2 are disposed on the side plate 3d of the case 2 in the present embodiment, but as long as light L from the LEDs 2 enters the cavity 5, there is no need for the LEDs 2 to necessarily be disposed on the side plate 3d of the case 3. It is possible to dispose the LEDs 2 on the top plate 3a or the bottom plate 3b of the case 3, for example. The location where the LEDs 2 can be disposed is therefore also flexible.

In the present embodiment, an example was described in which the plurality of lenses 7 and openings 6 are arranged in a regular fashion at an even pitch. However, as long as the focal point F of the lens 7 matches the position of the corresponding opening 6, the plurality of lenses 7 and openings 6 need not necessarily be arranged in a regular fashion. For example, the plurality of lenses 7 and openings 6 may be disposed randomly.

Also, the top plate 3a and the bottom plate 3b of the case 3 need not necessarily be parallel to each other.

### Embodiment 2

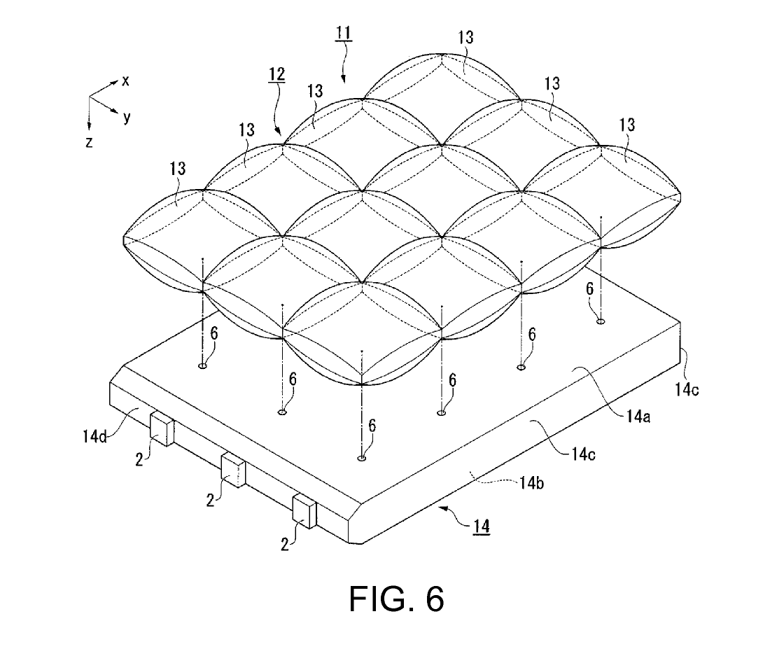

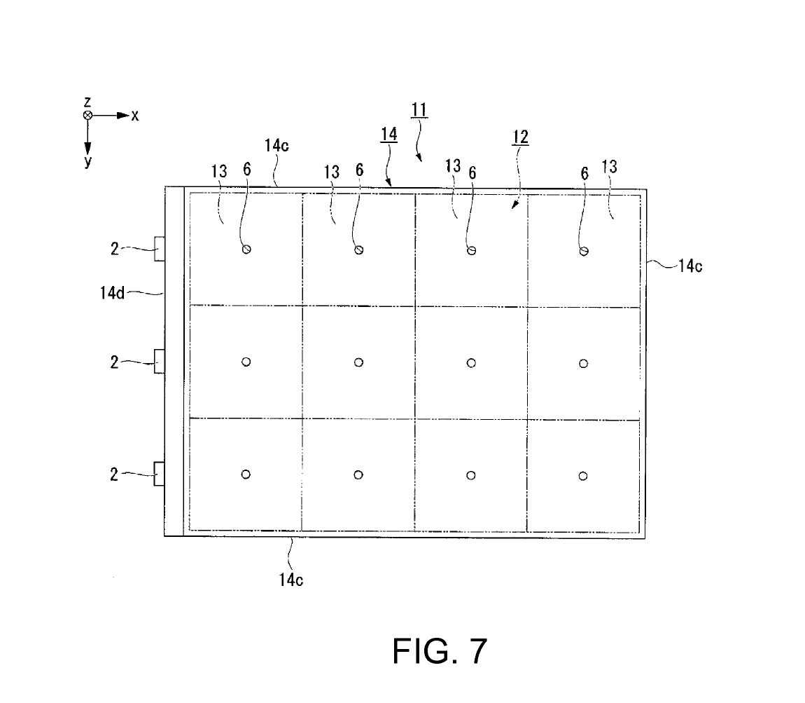

Below, Embodiment 2 of the present invention will be described with reference to FIGS. 6 and 7.

The basic structure of the planar light source device of the present embodiment is similar to that of Embodiment 1, with the configuration of the lens sheet differing from that of Embodiment 1.

FIG. 6 is a perspective view of a planar light source device of the present embodiment. FIG. 7 is a plan view of the planar light source device.

In FIGS. 6 and 7, components in common with the drawings for Embodiment 1 are assigned the same reference characters with descriptions thereof being omitted.

As shown in FIG. 6, the planar light source device 11 includes a plurality of LEDs 2 constituting the light source, a case 14, and a lens sheet 12 (lens member). The lens sheet 12 is a sheet-shaped member having a plurality of lenses 13 (unit lenses). The plan view shape of the lenses 13 when viewed in the direction normal to the lens sheet 12 is square in the present invention unlike in Embodiment 1 where the lenses 13 were circular.

As shown in FIG. 7, the lens sheet 12 of the present embodiment has 12 lenses 13 all having the same dimensions and shape. The 12 lenses 13 are arranged in a grid pattern of three rows and four columns. The lenses 13 are disposed such that the center of the square outline of the lenses 13 respectively match the openings 6. Therefore, the case 14 has 12 openings 6, the 12 openings 6 being arranged in a grid pattern at the same pitch in three rows and four columns. The reference character 14a represents the top plate, 14b represents the bottom plate, and 14c and 14d represent the side plates. Other configurations are similar to Embodiment 1.

In the planar light source device 11 of the present embodiment also, light having a high directivity and even distribution of light and luminance can be attained.

Also, because the lenses 7 are circular in Embodiment 1, it is impossible to dispose the lenses 7 without any gaps therebetween. Thus, the lens sheet 4 has flat portions aside from the lenses 7. By contrast, the lenses 13 of the present embodiment are square, and thus, as shown in FIG. 7, the lenses 13 can be disposed without any gap therebetween. By this configuration, the planar light source device 11 of the present embodiment can attain a more even luminance distribution compared to the planar light source device 1 of Embodiment 1.

<Modification Example of Planar Light Source Device>

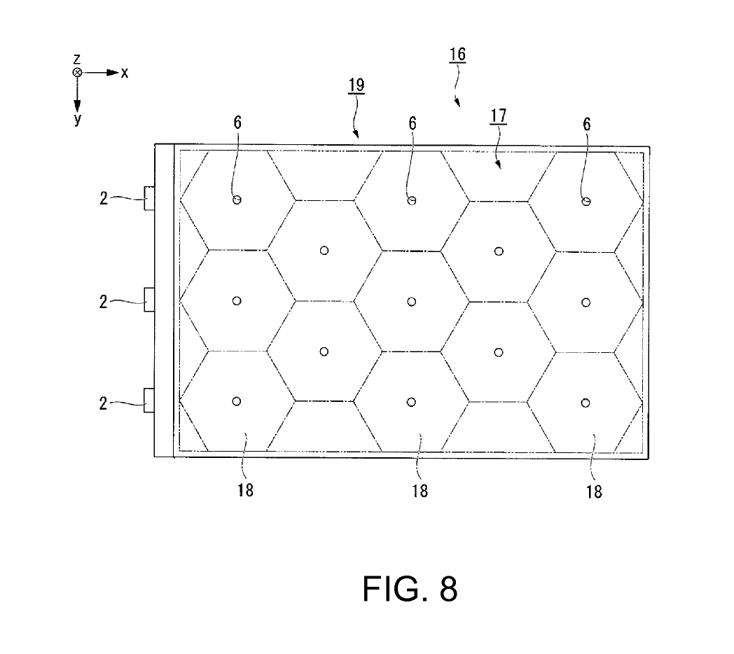

In the planar light source device 11 of the embodiment above, the lens sheet 12 had square lenses 13. As shown in FIG. 8, in the planar light source device 16 of the present modification example, the lens sheet 17 has a regular hexagonal shape. The reference character 19 indicates the case. Effects similar to the embodiment above can be attained using this planar light source device 16 also.

### Embodiment 3

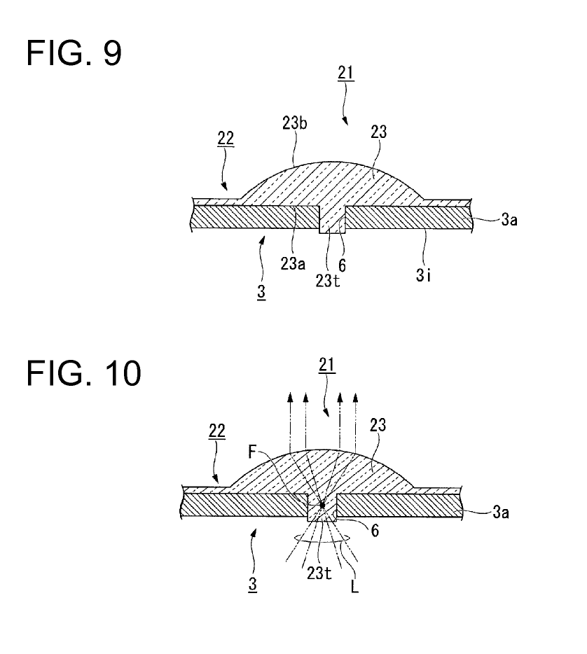

Below, Embodiment 3 of the present invention will be described with reference to FIGS. 9 and 10.

The basic structure of the planar light source device of the present embodiment is similar to that of Embodiment 1, with the configuration of the lens sheet differing from that of Embodiment 1.

FIG. 9 is a cross-sectional view of a main part of a planar light source device of the present embodiment. FIG. 10 shows a path of light in the planar light source device of the present embodiment.

In FIGS. 9 and 10, components in common with the drawings for Embodiment 1 are assigned the same reference characters with descriptions thereof being omitted.

As shown in FIG. 9, in a planar light source device 21 of the present embodiment, a lens 23 is a plano-convex lens constituted of one flat surface 23a and one spherical surface 23b. The flat surface 23a of the lens sheet 22 where light enters is attached to the top plate 3a of the case 3. A protrusion 23t is provided on the flat surface 23a of the lens 23, and the protrusion 23t is inserted into the opening 6 in the top plate 3a with no gap. As a result of the protrusion 23t of the lens 23 fitting into the opening 6 in this manner, the lens sheet 22 and the case 3 are aligned with respect to each other. In other words, as shown in FIG. 10, the protrusion 23t functions as an alignment portion for aligning the focal point F of the lens 23 in the opening 6. Other configurations are similar to Embodiment 1.

In order to attain light with a high directivity, it is necessary for the opening and the focal point of the lens to be aligned. Although not discussed in Embodiment 1, if the lens sheet is disposed away from the case, then a fixing structure to accurately fix the lens sheet with respect to the case is needed. According to the planar light source device 21 of the present embodiment, by fitting the protrusion 23t of the lens 23 in the opening 6 in the top plate 3a, the opening 6 and the focal point F of the lens 23 can be reliably aligned with respect to each other. As a result, light with a high directivity can be attained.

If the protrusion 23t is to be formed in the lens 23, then after forming the lens 23, for example, a photosensitive resin may be coated on the flat surface with the photosensitive resin being exposed by parallel light radiated from the convex surface. In such a case, the lens 23 causes light to focus at the focal point, which means portions of the photosensitive resin at the focal point and in the vicinity thereof are selectively exposed. By developing the photosensitive resin thereafter, the protrusion 23t is formed.

However, the method of forming the protrusion 23t is not limited to exposure/developing using a photosensitive resin. The protrusions 23t may be formed by injection molding, for example.

### Embodiment 4

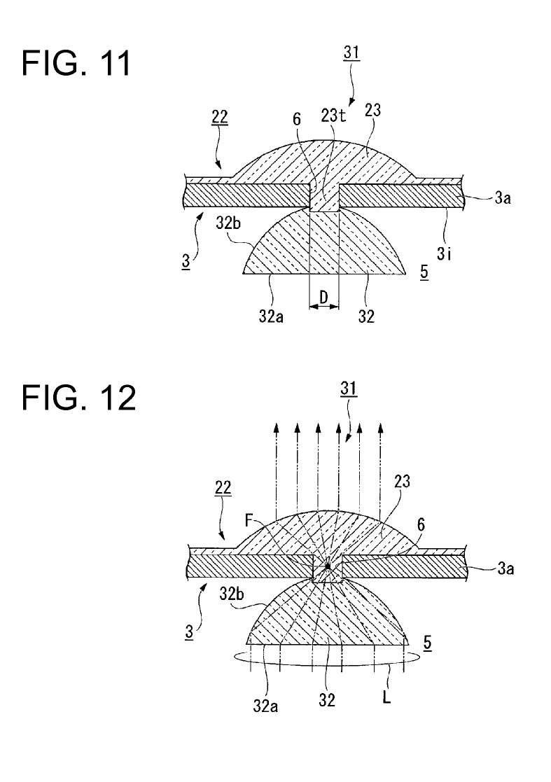

Below, Embodiment 4 of the present invention will be described with reference to FIGS. 11 and 12.

The basic structure of the planar light source device of the present embodiment is similar to that of Embodiment 1, but differs in that the present embodiment includes a focusing member inside the cavity.

FIG. 11 is a cross-sectional view of a main part of a planar light source device of the present embodiment. FIG. 12 shows a path of light in the planar light source device of the present embodiment.

In FIGS. 11 and 12, components in common with the drawings for Embodiment 1 are assigned the same reference characters with descriptions thereof being omitted.

In the planar light source device 31 of the present embodiment, as shown in FIG. 11, a telecentric lens 32 (non-focal lens) at a position corresponding to the opening 6 in the top plate 3a of the case 3. The telecentric lens 32 is a plano-convex lens that is fixed in place with the flat surface 32a thereof facing the interior of the cavity 5 and the convex surface 32b facing the top plate 3a. The top of the convex surface 32b corresponds in position to the opening 6. The configuration of the lens sheet 22 is similar to that of Embodiment 3. Other configurations are similar to Embodiment 1.

In order to attain light having a high directivity, it is preferable that the diameter D of the opening 6 be small. The reason for this is, the smaller the diameter of the opening 6 is, the less light passing through an area away from the focal point F enters the lens 23. As a result, a decrease in directivity can be mitigated. On the other hand, if the diameter of the opening 6 is small, this risks a decrease in light usage efficiency.

Thus, as shown in FIG. 12, a telecentric lens 32 is included in the planar light source device 31 of the present embodiment. The light L entering the flat surface 32a of the telecentric lens 32 is reflected by the convex surface 32b and is guided inside the telecentric lens 32, and focuses at the opening 6. In other words, the telecentric lens 32 functions as a focusing member that focuses the light L guided inside the cavity 5 in the opening 6. Therefore, according to the planar light source device 31 of the present embodiment, it is possible to increase the amount of light entering the opening 6 without changing the diameter of the opening 6. As a result, according to the planar light source device 31 of the present embodiment, it is possible to increase the light usage efficiency while maintaining a high directivity.

### Embodiment 5

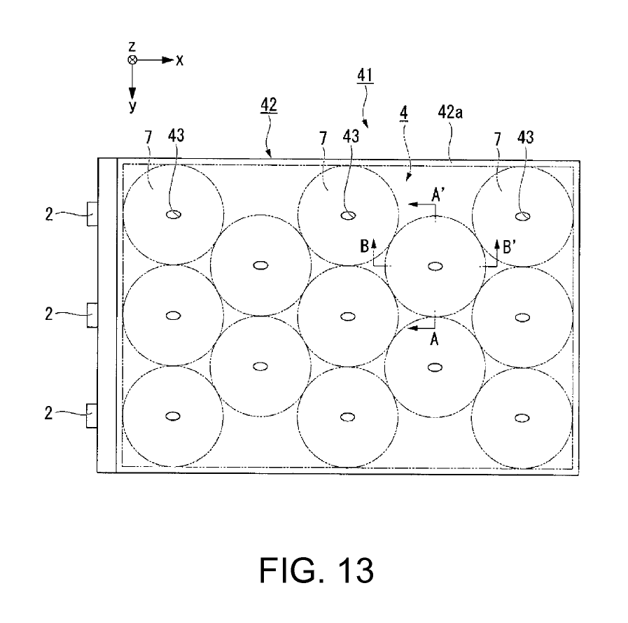

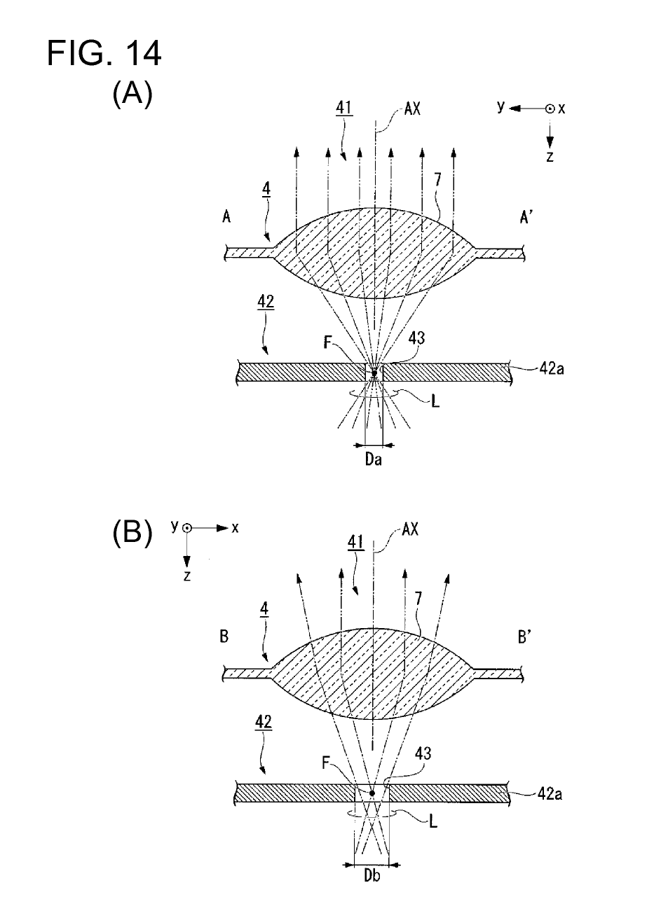

Below, Embodiment 5 of the present invention will be described with reference to FIGS. 13 and 14.

The basic structure of the planar light source device of the present embodiment is similar to that of Embodiment 1, but the shape of the opening differs from Embodiment 1.

FIG. 13 is a plan view of a planar light source device of the present embodiment. FIGS. 14(A) and 14(B) show the path of light in the planar light source device of the present embodiment; FIG. 14(A) is a cross-sectional view of FIG. 13 along the line A-A′, and FIG. 14(B) is a cross-sectional view of FIG. 13 along the line B-B′.

In FIGS. 13, 14(A) and 14(B), components in common with the drawings for Embodiment 1 are assigned the same reference characters with descriptions thereof being omitted.

In the planar light source device 1 of Embodiment 1, the openings 6 were circular in a plan view. By contrast, the planar light source device 41 of the present embodiment has openings 43 with an elliptical shape in a plan view formed in the top plate 42a of the case 42, as shown in FIG. 13. In the present embodiment, as one example, all openings 43 are formed such that the short axis direction of the ellipse is aligned with the y axis direction and the long axis direction of the ellipse is aligned with the x axis direction. However, not all of the openings 43 need to be aligned in this manner, and the alignment of some openings 43 may differ. Other configurations are similar to Embodiment 1.

The fact that the focal point F of the lens 7 matches the opening 43 in position is similar to Embodiment 1. However, in the case of the planar light source device 41 of the present embodiment, the behavior of the light differs slightly from that of Embodiment 1. In the present embodiment, the opening 43 is elliptical, and thus, the opening diameter differs depending on the direction. Thus, the diameter Da of the opening 43 is relatively small in the cross-section along the line A-A′ of FIG. 13 (short axis direction of ellipse) as shown in FIG. 14(A). Therefore, the amount of light L entering the lens 7 from a position away from the focal point F of the lens 7 is small, and the directivity in the yz plane is high. On the other hand, the diameter Db of the opening 43 is relatively large in the cross-section along the line B-B′ of FIG. 13 (long axis direction of ellipse) as shown in FIG. 14(B). Therefore, more light L enters the lens 7 from a position away from the focal point F of the lens 7, and the directivity in the xz plane is low.

In the planar light source device 1 of Embodiment 1 having circular openings 6, the directivity of light does not change depending on the direction, and is thus isotropic. By contrast, in the planar light source device 41 of the present embodiment having elliptical openings 43, there is variation in directivity of the emitted light. The directivity of light in the short axis direction of the opening 43 having an elliptical shape is lower than the directivity of light in the long axis direction of the ellipse. Thus, the planar light source device 41 of the present embodiment is suited to applications that require a high directivity in a specific direction, for example, but not as high of a directivity in the other direction.

<Modification Example of Planar Light Source Device>

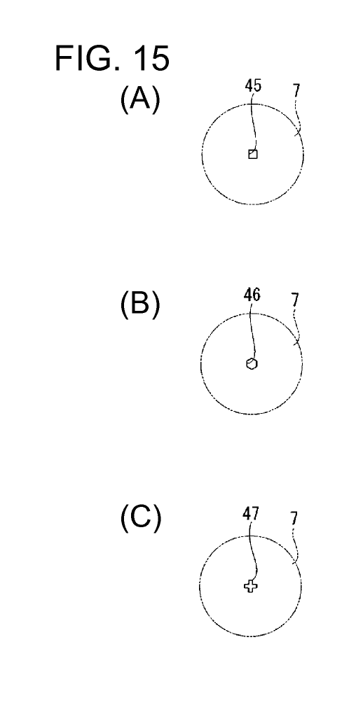

The planar light source device 1 of Embodiment 1 has circular openings 6 and the planar light source device 41 of Embodiment 5 has elliptical openings 43. A planar light source device having openings as described below may be used instead. As shown in FIG. 15(A), for example, openings 45 that are square in a plan view may be provided. Alternatively, as shown in FIG. 15(B), for example, openings 46 that have a regular hexagonal shape in a plan view may be provided. Alternatively, as shown in FIG. 15(C), for example, openings 47 that have a cross shape in a plan view may be provided. Effects similar to the embodiment above can be attained using these configurations also. Alternatively, the openings may have an indefinite shape.

### Embodiment 6

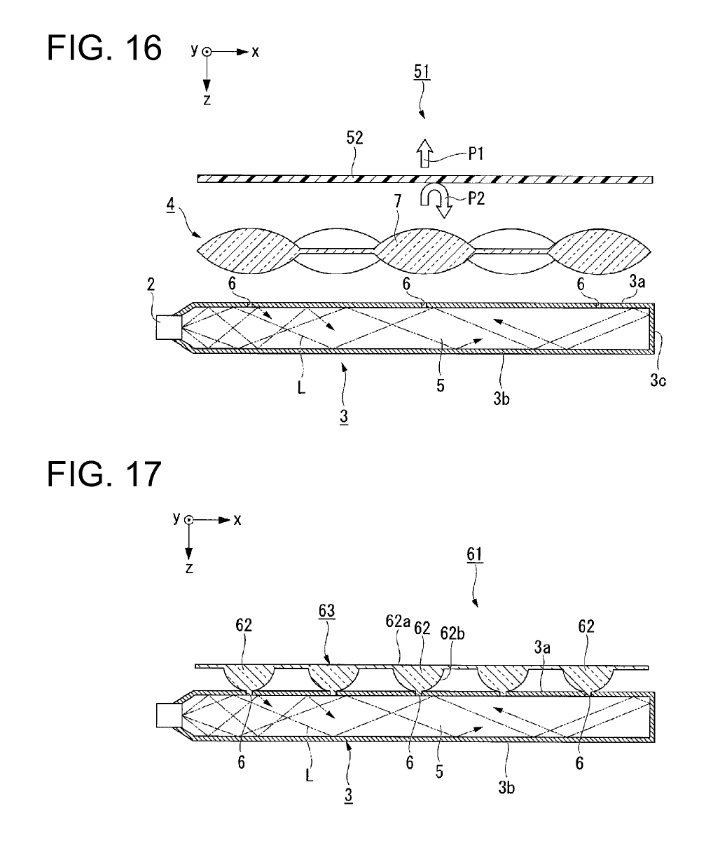

Embodiment 6 of the present invention will be described below with reference to FIG. 16.

The basic structure of the planar light source device of the present embodiment is similar to that of Embodiment 1, but differs in that the present embodiment includes a reflective polarizing film.

FIG. 16 is a cross-sectional view of a planar light source device of the present embodiment.

In FIG. 16, components in common with the drawings for Embodiment 1 are assigned the same reference characters with descriptions thereof being omitted.

As shown in FIG. 16, the planar light source device 51 of the present embodiment includes a reflective polarizing film 52 (selective polarizing element) on the light emitting side of the lens sheet 4. The reflective polarizing film 52 has the function of allowing through a first polarized light P1 having a specific polarized state and reflecting a second polarized light P2 having a polarized state differing from the polarized state of the first polarized light, among light emitted from the lens sheet 4. DBEF (registered trademark; Sumitomo 3M) can be used for the reflective polarizing film 52, for example. Other configurations are similar to Embodiment 1.

In the present embodiment, the second polarized light P2 reflected by the reflective polarizing film 52 is focused by the lens 7 and returns to the cavity 5 through the opening 6. If the second polarized light P2 changes in polarizing state after being repeatedly reflected in the cavity 5, and becomes the first polarized light P1 by the time it enters the reflective polarizing film 52 through the lens sheet 4, then this light can pass through the reflective polarizing film 52. According to the planar light source device 51 of the present embodiment, it is possible to attain light with a high directivity and to allow through only light having a specific polarization efficiently as described above. Thus, the planar light source device 51 of the present embodiment can be suitably used in a liquid crystal display device that performs display using polarized light.

### Embodiment 7

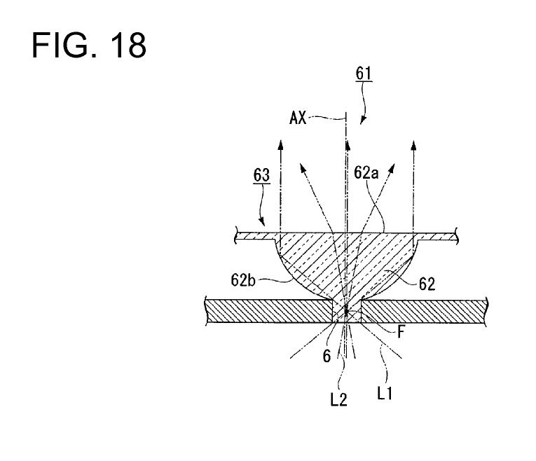

Below, Embodiment 7 of the present invention will be described with reference to FIGS. 17 and 18.

The basic structure of the planar light source device of the present embodiment is similar to that of Embodiment 1, with the configuration of the lens sheet differing from that of Embodiment 1.

FIG. 17 is a cross-sectional view of a planar light source device of the present embodiment. FIG. 18 shows a path of light in the planar light source device of the present embodiment.

In FIGS. 17 and 18, components in common with the drawings for Embodiment 1 are assigned the same reference characters with descriptions thereof being omitted.

The lenses in Embodiments 1 to 6 were spherical lenses. By contrast, as shown in FIG. 17, the planar light source device 61 of the present embodiment includes a lens sheet 63 having a plurality of parabolic lenses 62. The parabolic lenses 62 are plano-convex lenses fixed such that the flat surface 62a thereof faces the direction towards which light is emitted, and the parabolic surface 62b faces the top plate 3a. The focal point F of the parabolic lens 62 matches in position with the opening 6. Other configurations are similar to Embodiment 1.

As shown in FIG. 18, in the present embodiment, the light L1 entering the parabolic lens 62 at a large angle of incidence is reflected by the parabolic surface 62b and is emitted as light parallel to the optical axis AX of the parabolic lens 62. On the other hand, light L2 entering at a small angle of incidence with respect to the parabolic lens 62 is not reflected by the parabolic surface 62b and is refracted by the flat surface 62a as it exits. In this manner, in the planar light source device 61 of the present embodiment, some of the light entering the parabolic lens 62 is emitted without being reflected by the parabolic surface, and thus, completely parallel light cannot be attained. However, according to the planar light source device 61 of the present embodiment, light having a sufficient directivity can be attained.

### Embodiment 8

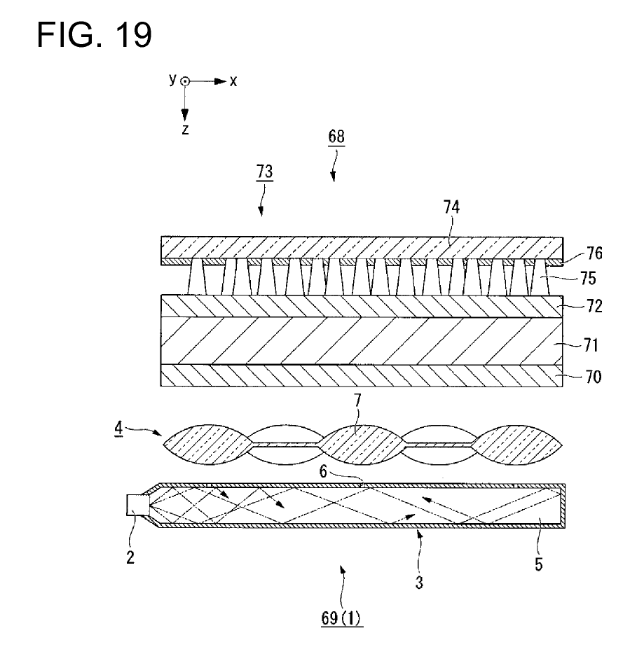

Embodiment 8 of the present invention will be described below with reference to FIG. 19.

In Embodiments 8 and 9 below, examples will be given of display devices including the planar light source devices of the embodiments above. The present embodiment is an example of a liquid crystal display device including the planar light source device of Embodiment 1 as a backlight.

FIG. 19 is a cross-sectional view showing a liquid crystal display device according to the present embodiment.

In FIG. 19, components in common with the drawings for Embodiment 1 are assigned the same reference characters with descriptions thereof being omitted.

As shown in FIG. 19, the liquid crystal display device 68 of the present embodiment includes a backlight 69, which includes the planar light source device 1 of Embodiment 1, a first polarizing plate 70, a liquid crystal panel 71, a second polarizing plate 72, and a viewing angle expansion film 73 (light scattering member). In FIG. 19, one liquid crystal panel 71 is schematically shown in a plate shape. The viewer would view images from the top of the liquid crystal display device 68 of FIG. 19 where the viewing angle expansion film 73 is disposed. Thus, in the description below, the side where the viewing angle expansion film 73 is disposed is referred to as the viewer's side, and the side where the backlight 69 is disposed is referred to as the rear side.

In the liquid crystal display device 68 of the present embodiment, the light emitted from the backlight 69 is modulated by the liquid crystal panel 71 and prescribed images, characters, and the like are displayed by the modulated light. When light emitted from the liquid crystal panel 71 passes through the viewing angle expansion film 73, light having a wider angle distribution than before it enters the viewing angle expansion film 73 exits from the viewing angle expansion film 73. Thus, the viewer see images at a wide viewing angle.

The liquid crystal panel 71 can be an active matrix transmissive liquid crystal panel, for example. However, the liquid crystal panel 71 is not limited to an active matrix transmissive liquid crystal panel, and may be a transflective (transmissive and reflective) liquid crystal panel, or a simple matrix liquid crystal panel in which the pixels are not provided with thin film transistors (hereinafter TFTs) for switching. A well-known general liquid crystal panel can be used for the liquid crystal panel 71, and thus detailed descriptions of the configuration thereof will be omitted.

The viewing angle expansion film 73 is disposed on the viewer's side of the liquid crystal display device 68. The viewing angle expansion film 73 includes a substrate 74, a plurality of light scattering units 75 formed on one surface of the substrate (surface opposite to the viewer's side), and a light-absorption layer 76 formed on one surface of the substrate 74. The viewing angle expansion film 73 is disposed over the second polarizing plate 72 such that the side provided with the light scattering units 75 faces the second polarizing plate 72, and the substrate 74 faces the viewer's side.

It is preferable that the substrate 74 be made of a transparent resin base material such as a triacetyl cellulose (TAC) film. The light scattering unit 75 is made of a light-transmissive and photosensitive organic material such as an acrylic resin or an epoxy resin, for example. The light scattering unit 75 has a circular shape in a horizontal cross-section (xy cross-section), the surface towards the base material 74 to be the light-emission edge face has a small area, and the surface opposite to the base material 74 to be the light-receiving surface has a large area; the horizontal cross-sectional area becomes gradually larger from the base material 74 side to the side opposite to the base material 74. In other words, the light scattering unit 75 has a so-called reverse tapered cone shape when viewed from the base material 74 side. The light scattering unit 75 is a portion that contributes to the transmission of light in the viewing angle expansion film 73. In other words, light entering the light scattering units 75 is completely reflected by the tapered side face of the light scattering units 75 and is guided while being almost completely trapped in the light scattering units 75, and is emitted so as to be scattered in all directions.

The light-absorption layer 76 is formed on the side of the base material 74 where the light scattering units 75 are formed but in areas other than where the plurality of light-absorption layers 75 are formed. As an example, the light-absorption layer 76 is made of a light-absorbing and photosensitive organic material such as black resist.

If image quality adjustment is performed on the liquid crystal display device with light transmitted to the front of the display surface, or in other words, perpendicular to the liquid crystal panel as a reference, then in liquid crystal display devices using conventional backlights with not directivity, the color differs between when the display surface is viewed from the front and when the display surface is viewed from the diagonal direction. By contrast, in the liquid crystal display device 68 of the present embodiment, the backlight 69 including the planar light source device 1 of Embodiment 1 having a high directivity in both the x axis direction and the y axis direction is used. As a result, light only at an angle range with little color variation passes through the liquid crystal panel 71. Then, the light is scattered in all directions by the viewing angle expansion film 73, and thus, the viewer can see a high quality image with little color variation at any angle.

### Embodiment 9

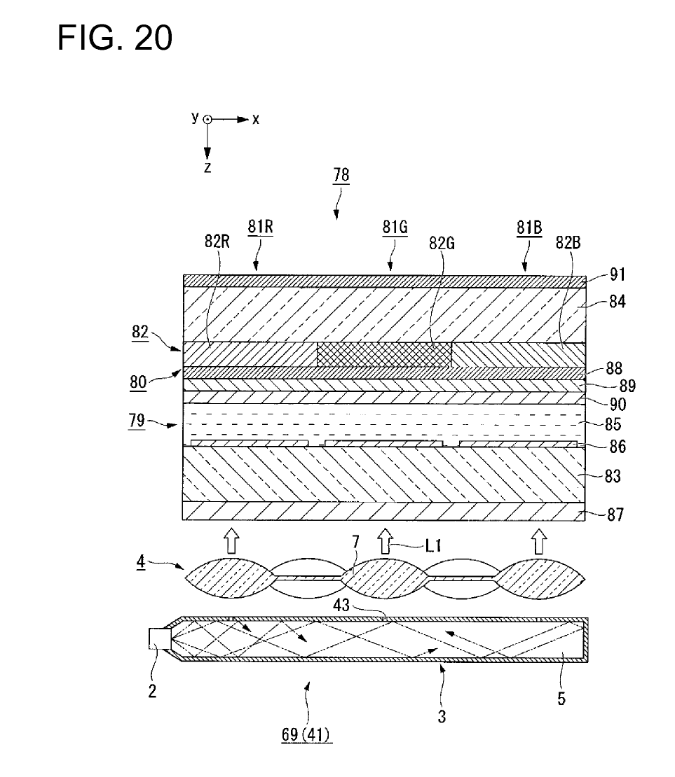

Embodiment 9 of the present invention will be described below with reference to FIG. 20.

The present embodiment is an example of a fluorescent liquid crystal display device including the planar light source device of Embodiment 5 as a backlight.

As shown in FIG. 20, the liquid crystal display device 78 of the present embodiment includes a backlight 69 (planar light source device) including the planar light source device 41 of Embodiment 5, a liquid crystal element 79, and a light-emitting element 80. The liquid crystal display device 78 of the present embodiment has red sub-pixels 81R performing display with red light, green sub-pixels 81G performing display with green light, and blue sub-pixels 81B performing display with blue light, arranged adjacent to each other. One pixel, which is the minimum unit of display, is constituted of these three sub-pixels 81R, 81G, and 81B.

The backlight 69 emits excitation light L1 generated by fluorescent layers 82R, 82G, and 82B of the light-emitting element 80. The backlight 69 of the present embodiment emits ultraviolet or blue light as the excitation light L1. The liquid crystal element 79 modulates the transmittance of the excitation light L1 emitted from the backlight 69 for each sub-pixel 81R, 81G, and 81B. The light-emitting element 80 receives excitation light L1 modulated by the liquid crystal element 79, which excites the fluorescent layers 82R, 82G, and 82B, allowing light to be emitted outside. Thus, in the present embodiment, the upper side of the liquid crystal display device 78 shown in FIG. 20 is the viewer's side from which the viewer sees the display.

In the present embodiment, the planar light source device 41 of Embodiment 5 having the elliptical openings 43 is used as the backlight 69. The short axis direction of the openings 43, which are elliptical in a plan view, matches the direction in which the sub-pixels 81R, 81G, and 81B are aligned (x axis direction in FIG. 20). The long axis direction of the openings 43, which are elliptical in a plan view, matches a direction perpendicular to the direction in which the sub-pixels 81R, 81G, and 81B are aligned (y axis direction in FIG. 20). Thus, light having a relatively high directivity in the direction in which the sub-pixels 81R, 81G, and 81B are aligned, and a relatively low directivity in the direction perpendicular to the alignment direction of the sub-pixels 81R, 81G, and 81B is emitted from the backlight 69.

The liquid crystal element 79 has a liquid crystal layer 85 sandwiched between a first transparent substrate 83 and a second transparent substrate 84. In the present embodiment, the second transparent substrate 84 located towards the front as seen from the viewer doubles as a substrate of the light-emitting element 80. First transparent electrodes 86 are formed for each sub-pixel on the inner surface (surface facing the liquid crystal layer 85) of the first transparent substrate 83, and an alignment film (not shown) is formed to cover the first transparent electrodes 86. The first polarizing plate 87 is provided on the outer surface of the first transparent substrate 83 (surface opposite to the liquid crystal layer side). A substrate that can transmit excitation light made of a material such as glass, quartz, or plastic, for example, can be used for the first transparent substrate 83. A transparent conductive material such as indium tin oxide (hereinafter ITO), for example, is used for the first transparent electrode 86. A conventionally known externally disposed polarizing plate can be used for the first polarizing plate 87.

On the other hand, the fluorescent layer 82 and the first light-absorption layer 88 are layered in this order from the inner surface (surface facing the liquid crystal layer 85) of the second transparent substrate 84. The fluorescent material of the fluorescent layer 82 has different light-emitting frequency bands for each sub-pixel. If the excitation light from the backlight 69 is ultraviolet light, then a fluorescent layer 82R made of a fluorescent material that absorbs ultraviolet light and emits red light is provided for the red sub-pixel 81R. Similarly, a fluorescent layer 82G made of a fluorescent material that absorbs ultraviolet light and emits green light is used for the green sub-pixel 81G. A fluorescent layer 82B made of a fluorescent material that absorbs ultraviolet light and emits blue light is used for the blue sub-pixel 81B.

Alternatively, then if the excitation light from the backlight 69 is blue light, then fluorescent layers 82R and 82G made of fluorescent materials that absorb blue light and respectively emit red light and green light are used for the red sub-pixel 81R and the green sub-pixel 81G. In the blue sub-pixel 81B, a light-scattering layer that scatters and emits the blue excitation light without modulating the frequency thereof is provided instead of the fluorescent layer. Also, the second polarizing plate 89 is formed so as to cover the first light-absorption layer 88 on the inner surface of the second substrate 84, and the second transparent electrode 90 and an alignment film (not shown) are layered on the surface of the second polarizing plate 89. The second polarizing plate 89 is a so-called in-cell polarizing plate, which is built in during the manufacturing process of the liquid crystal element 79 by a coating technique or the like. A second transparent electrode 90 is made of a transparent conductive material such as ITO, similar to the first transparent electrodes 86.

The second light-absorption layer 91 is formed on the outer surface of the second transparent substrate 84. The first light-absorption layer 88 provided on the inner surface of the second transparent substrate 84 is for mitigating a decrease in contrast that would result from a leakage of the excitation light L1 from the backlight 69. The second light-absorption layer 91 provided on the outer surface of the second transparent substrate 84 is for mitigating a decrease in contrast that would result from external light.

Color variation occurs when viewing a normal liquid crystal display device from a diagonal direction as described in Embodiment 8. By contrast, the fluorescent excitation liquid crystal display device 78 of the present embodiment uses as the backlight 69 a planar light source device that emits ultraviolet light or blue light having a relatively high directivity in the direction in which the sub-pixels 81R, 81G, and 81B are aligned, and the color of the ultraviolet light or blue light is modulated by the fluorescent layer 82. At this time, the light of the respective colors is emitted isotropically, and thus, the viewer can see a high quality image with little change in color no matter the direction from which the display screen is viewed.

<Configuration Example of Display Device>

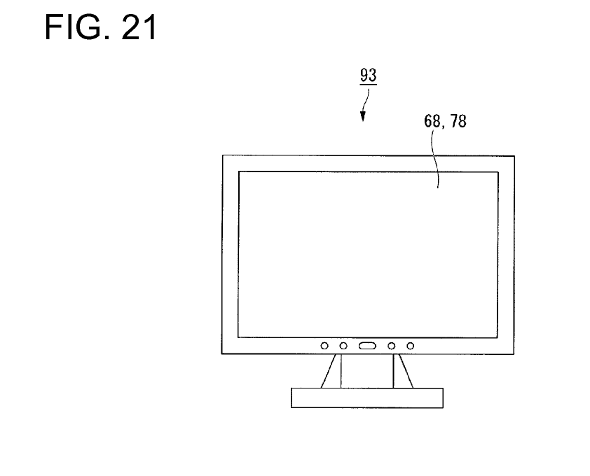

Below, a configuration example of the display device will be described with reference to FIG. 21.

FIG. 21 is a front view showing a schematic configuration of a liquid crystal display device, as a configuration example of a display device.

A liquid crystal television 93 of the present configuration example includes the liquid crystal display device 68 of Embodiment 8 or the liquid crystal display device 78 of Embodiment 9 as the display screen. A liquid crystal panel is disposed on the viewer side (front in FIG. 21) and a backlight (planar light source device) is disposed on the side opposite to the viewer (to the rear of FIG. 21).

The liquid crystal television 93 of the present configuration example includes the liquid crystal display device 68 or 78 of the embodiments above, and thus, can perform display at a high quality.

### Embodiment 10

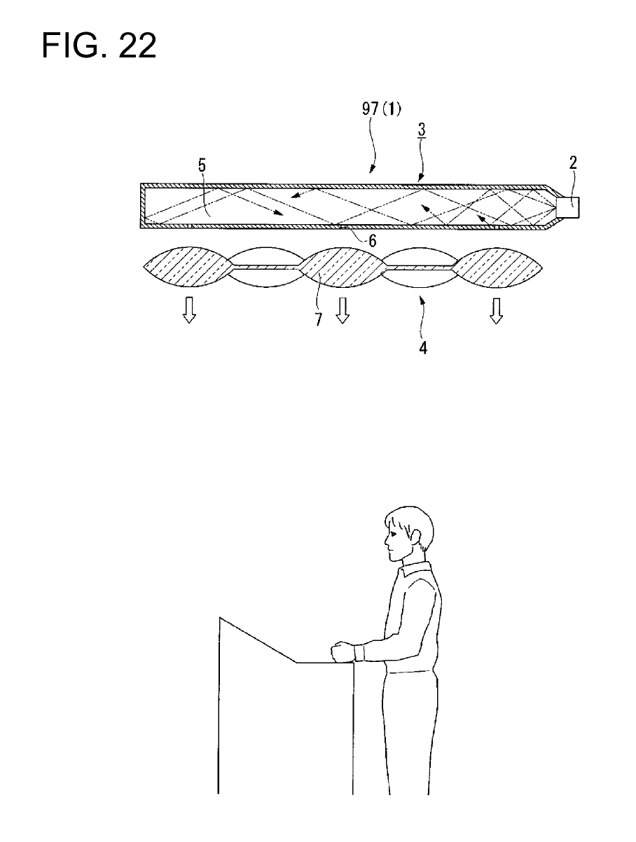

Below, Embodiment 10 of the present invention will be described with reference to FIG. 22.

In Embodiment 10, an example will be given of an illumination device including the planar light source device of Embodiment 1.

FIG. 22 is a cross-sectional view showing an illumination device according to the present embodiment.

In FIG. 22, components in common with the drawings for Embodiment 6 are assigned the same reference characters with descriptions thereof being omitted.

As shown in FIG. 22, an illumination device 97 of the present embodiment includes the planar light source device 1 of Embodiment 1. Thus, the illumination device 97 of the present embodiment has a high directivity and the brightness distribution is even. Thus, according to the illumination device 97 of the present embodiment, illumination light is focused in a narrow area and has an even brightness in this area. If the illumination device 97 of the present embodiment is installed close to a ceiling of a hall, high directivity light is radiated downward from the illumination device 97, and thus, the illumination device 97 is suited to being used as a spotlight, for example.

The technical field of the present invention is not limited to those of the embodiments above, and various modifications can be made within a range that does not deviate from the gist of the present invention.

For example, in the embodiments above, the transmissive portion is an opening for allowing light to escape the case, but the transmissive portion need not necessarily be an opening. For example, the opening can be a transmissive portion in which the opening is covered by a transparent member as long as light can escape therethrough. In the embodiments above, the planar light source device included only one case, but if using a large planar light source device, for example, a configuration in which a plurality of cases are tiled such that the light-emitting surface is an even plane may be used.

In the embodiments above, LEDs were used as the light source, but the light source is not limited to LEDs, and another light source such as a cold cathode ray tube can be used. When using a plurality of light sources as in the embodiments above, the light sources need not necessarily be disposed at equal gaps, and may be disposed such that the concentration of light sources varies. Similarly, the transmissive portions and the lens need not necessarily be disposed at equal gaps, and may be disposed such that the concentration thereof varies. At least one of the transmissive portion and the lens needs to be provided. Otherwise, specific configurations such as the number, arrangement, and materials of the components of the planar light source devices described in the embodiments above can be modified as appropriate.

### INDUSTRIAL APPLICABILITY

The present invention can be used in various display devices such as liquid crystal display devices, organic electroluminescent display devices, and plasma display devices.

### DESCRIPTION OF REFERENCE CHARACTERS

1, 11, 16, 21, 31, 41, 51, 61 planar light source device
2 light emitting diode (LED light source)
3, 14, 19, 42 case
4, 12, 17, 22, 63 lens sheet (lens member)
5 cavity
6, 43, 45, 46, 47 opening (light-transmissive portion)
7, 13, 18, 23, 62 lens (unit lens)
23t protrusion (alignment portion)
32 telecentric lens (focusing member)
52 reflective polarizing film (selective polarization element)
68, 78 liquid crystal display device (display device)
69 backlight (planar light source device)
71 liquid crystal panel
97 illumination device
F focal point of lens

1. A planar light source device, comprising:
a case having a light source and a light-emitting surface provided with at least one light-transmissive portion, the case guiding light from the light source as said light is reflected a plurality of times in an interior space of the case and emitting the light from the light-transmissive portion;
a lens member including at least one unit lens disposed to face the light-emitting surface of the case,
wherein a focal point of the unit lens substantially matches the light-transmissive portion in position.

2. The planar light source device according to claim 1,
wherein a plurality of said light-transmissive portions are provided in the light-emitting surface of the case, and
wherein the lens member includes a plurality of said unit lenses respectively corresponding in position to the plurality of light-transmissive portions.

3. The planar light source device according to claim 1, wherein the light-transmissive portion is an opening provided in the case.

4. The planar light source device according to claim 1, wherein at least some inner surfaces of the case are scatter-reflective surfaces that reflect and scatter light from the light source.

5. The planar light source device according to claim 1, wherein at least some inner surfaces of the case are specular reflective surfaces that specularly reflect light from the light source.

6. The planar light source device according to claim 1, wherein the unit lens is a double convex lens.

7. The planar light source device according to claim 1, wherein the unit lens is a plano-convex lens.

8. The planar light source device according to claim 6, wherein the unit lens is a parabolic lens.

9. The planar light source device according to claim 1, wherein the lens member includes an alignment portion for aligning the focal point of the unit lens in position with the light-transmissive portion.

10. The planar light source device according to claim 9,
wherein the light-transmissive portion is an opening provided in the case, and
wherein the alignment portion is a protrusion of the unit lens inserted into the opening that is the light-transmissive portion.

11. The planar light source device according to claim 1, wherein the light-transmissive portion is circular in a plan view when viewed from a direction normal to the light-emitting surface of the case.

12. The planar light source device according to claim 1, wherein the light-transmissive portion has a shape other than a circle in a plan view when viewed from a direction normal to the light-emitting surface of the case.

13. The planar light source device according to claim 1, wherein the unit lens is polygonal in a plan view when viewed from a direction normal to the light-emitting surface of the case.

14. The planar light source device according to claim 1, further comprising:
a light focusing member in the inner space of the case, the light focusing member focusing light guided in the inner space at the light-transmissive portion.

15. The planar light source device according to claim 14, wherein the light focusing member is a telecentric lens.

16. The planar light source device according to claim 1, further comprising:
a selective polarization element on a light emitting side of the lens member, the selective polarization element allowing through a first polarized light and reflecting a second polarized light having a differing polarization state from the first polarized light among the light emitted from the lens member.

17. The planar light source device according to claim 1, wherein a portion of the outer surface of the case facing the lens member is a light-absorbing surface.

18. A display device, comprising:
the planar light source device according to claim 1; and
a display element that performs display using light emitted from the planar light source device.

19. The display device according to claim 18, wherein the display element is a liquid crystal panel that modulates a transmittance of light emitted from the planar light source device.

20. The display device according to claim 19, further comprising:
a light scattering member for increasing a scattering angle of light emitted from the liquid crystal panel, the light scattering member being disposed on a light-emitting side of the liquid crystal panel.

21. The display device according to claim 18, wherein the display element is a fluorescent display that emits fluorescent light as light excited by the light from the planar light source device.

22. An illumination device, comprising:
the planar light source device according to claim 1.
